(19) United States
(12) Patent Application Publication
(10) Pub. No.: US 2026/0016813 A1
(43) Pub. Date: Jan. 15, 2026

(54) METHODS, INTERNET OF THINGS (IOT) SYSTEMS, AND MEDIA FOR HYDROGEN-BLENDED GAS TRANSMISSION OF SMART GAS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei ZHANG, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/337,874

(22) Filed: Sep. 23, 2025

(30) Foreign Application Priority Data
Aug. 27, 2025 (CN) 202511208618.1

(51) Int. Cl. G05B 19/416

(52) U.S. Cl. CPC G05B 19/416; G05B 2219/37371

(57) ABSTRACT

Methods, Internet of Things (IoT) systems, and media for hydrogen-blended gas transmission of smart gas are provided. The method may be based on a gas company management platform of an Internet of Things (IoT) system for hydrogen-blended gas transmission of smart gas. The method may include: obtaining gas data of a preset gas pipeline and end-user demand data of gas end-user equipment corresponding to the preset gas pipeline; determining hydrogen blending data of the preset gas pipeline based on the gas data and the end-user demand data; and determining an injection parameter based on the hydrogen blending data and send the injection parameter to the hydrogen input device corresponding to the preset gas pipeline for controlling the hydrogen pressure regulation unit of the hydrogen input device to inject hydrogen into the preset gas pipeline in accordance with the injection parameter.

### CROSS-REFERENCE TO RELATED APPLICATIONS

This application claims priority of Chinese Patent Application No. 202511208618.1, filed on Aug. 27, 2025, the entire contents of which are hereby incorporated by reference.

### TECHNICAL FIELD

The present disclosure relates to the field of gas transmission, and in particular, to methods, Internet of Things (IoT) systems, and media or hydrogen-blended gas transmission of smart gas.

### BACKGROUND

The application of hydrogen-blended natural gas not only increases the calorific value of natural gas but also significantly reduces carbon dioxide emissions. However, the lifecycle management of hydrogen-blended gas faces multifaceted challenges. The lifecycle encompasses the entire process of production, transmission, and utilization. During production and transmission, the addition of hydrogen, a highly flammable and explosive gas, requires extra attention to its proportion in the blend. This is crucial to ensure pipeline network safety throughout these stages. In the utilization phase, since the calorific value of methane, which is the main component of natural gas, differs from that of hydrogen, the hydrogen proportion also impacts the combustion performance of hydrogen-blended gas.

Therefore, it is necessary to provide methods, Internet of Things (IoT) systems, and media or hydrogen-blended gas transmission of smart gas to better ensure the safety and stability of the production and transmission processes, as well as optimize the combustion performance of hydrogen-blended gas.

### SUMMARY

One or more embodiments of the present disclosure provide an Internet of Things (IoT) system for hydrogen-blended gas transmission of smart gas. The IoT system may include: a user platform, a government supervision service platform, a government supervision management platform, a government supervision sensor network platform, a government supervision object platform, a gas company sensor network platform, and a smart gas device object platform; the user platform is configured to obtain end-user demand data for a preset gas pipeline and upload the end-user demand data to the government supervision management platform by the government supervision service platform; the government supervision management platform includes a government safety supervision management platform; the government supervision service platform includes a government safety supervision service platform; the government supervision sensor network platform includes a government safety supervision sensor network platform; the government supervision object platform includes a gas company management platform; the smart gas device object platform includes a hydrogen input device and a gas monitoring device, the hydrogen input device is provided in the preset gas pipeline; wherein the hydrogen input device includes a hydrogen storage unit, a hydrogen buffer unit, a hydrogen pressure regulation unit, and a transmission pipeline; the hydrogen storage unit, the hydrogen buffer unit, and the hydrogen pressure regulation unit are connected by the transmission pipeline; the hydrogen storage unit stores hydrogen gas input to a gas pipeline network, the hydrogen buffer unit is configured to buffer the hydrogen gas input to the gas pipeline network, and the hydrogen pressure regulation unit is configured to regulate an output hydrogen pressure based on an injection parameter; and the gas monitoring device is provided in a gas pipeline of the gas pipeline network for obtaining gas data of the gas pipeline; the gas company management platform is configured to: obtain gas data of the preset gas pipeline from the smart gas device object platform by the gas company sensor network platform; determine hydrogen blending data of the preset gas pipeline based on the gas data and the end-user demand data; and determine the injection parameter based on the hydrogen blending data and send the injection parameter to the hydrogen input device corresponding to the preset gas pipeline for controlling the hydrogen pressure regulation unit of the hydrogen input device to inject hydrogen into the preset gas pipeline in accordance with the injection parameter.

One or more embodiments of the present disclosure provide a method for hydrogen-blended gas transmission of smart gas. The method may be implemented based on a gas company management platform of an Internet of Things (IoT) system for hydrogen-blended gas transmission of smart gas. The method may include: obtaining gas data of a preset gas pipeline and end-user demand data of gas end-user equipment corresponding to the preset gas pipeline; determining hydrogen blending data of the preset gas pipeline based on the gas data and the end-user demand data; and determining an injection parameter based on the hydrogen blending data and send the injection parameter to the hydrogen input device corresponding to the preset gas pipeline for controlling the hydrogen pressure regulation unit of the hydrogen input device to inject hydrogen into the preset gas pipeline in accordance with the injection parameter.

One or more embodiments of the present disclosure provide a non-transitory computer-readable storage medium storing computer instructions. When reading the computer instructions in the storage medium, a computer may implement the method for hydrogen-blended gas transmission of smart gas.

### BRIEF DESCRIPTION OF THE DRAWINGS

The present disclosure will be further illustrated with reference to a plurality of exemplary embodiments, described in detail using the accompanying drawings. These embodiments are not limiting, and in these embodiments, the same numbering denotes the same structure, wherein:

FIG. 1 is a schematic diagram illustrating a system structure of an Internet of Things (IoT) system for hydrogen-blended gas transmission of smart gas according to some embodiments of the present disclosure;

FIG. 2 is a flowchart illustrating an exemplary process for hydrogen-blended gas transmission of smart gas according to some embodiments of the present disclosure;

FIG. 3 is a schematic diagram illustrating a process for determining hydrogen blending data according to some embodiments of the present disclosure; and

FIG. 4 is a schematic diagram illustrating a process for determining an injection parameter according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

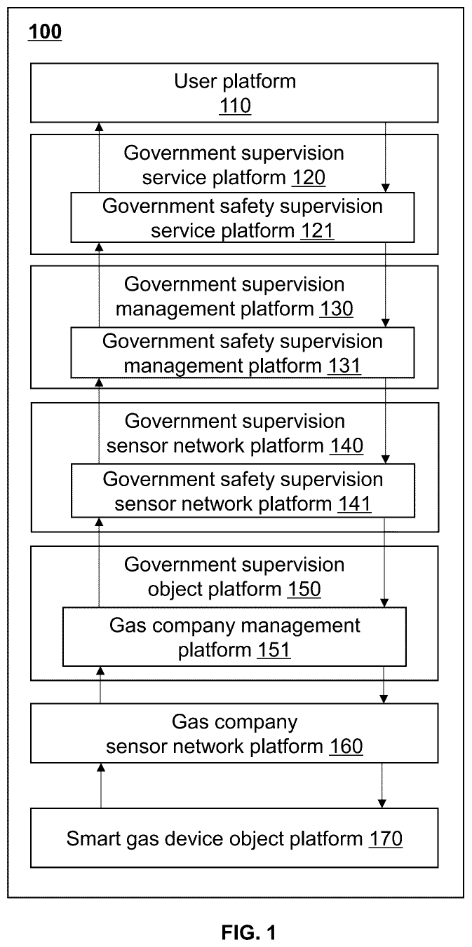

FIG. 1 is a schematic diagram illustrating a system structure of an Internet of Things (IoT) system for hydrogen-blended gas transmission of smart gas according to some embodiments of the present disclosure. The following provides a detailed description of the IoT system for hydrogen-blended gas transmission of smart gas covered by some embodiments of the present disclosure. It should be noted that the following embodiments are used only for the purpose of interpreting the present disclosure and do not constitute a limitation of the present disclosure.

In some embodiments, as shown in FIG. 1, the IoT system for hydrogen-blended gas transmission of smart gas 100 includes a user platform 110, a government supervision service platform 120, a government supervision management platform 130, a government supervision sensor network platform 140, a government supervision object platform 150, a gas company sensor network platform 160, and a smart gas device object platform 170.

The user platform 110 refers to a platform for interacting with a user. In some embodiments, the user platform is configured to obtain end-user demand data for a preset gas pipeline, and upload the preset gas pipeline to a government supervision management platform via a government supervision service platform. In some embodiments, the user platform is configured as a terminal device.

In some embodiments, the user platform 110 may exchange data with the government supervision service platform 120.

The government supervision service platform 120 refers to a platform for the government to receive and process sensor information. In some embodiments, the government supervision service platform 120 includes a government safety supervision service platform 121.

In some embodiments, the government supervision service platform 120 may exchange data with the government supervision management platform 130.

The government safety supervision service platform 121 refers to a platform for the government to receive and process safety-related perception information.

In some embodiments, the government safety supervision service platform 121 may exchange data with the user platform 110.

The government supervision management platform 130 refers to a comprehensive management platform for government to process and supervise information.

In some embodiments, the government supervision management platform 130 is configured to supervise a gas company management platform 151 to perform a method for hydrogen-blended gas transmission of smart gas. More descriptions regarding the method for hydrogen-blended gas transmission of smart gas may be found in the related descriptions below.

In some embodiments, the government supervision management platform 130 may further include a processor. The processor may process data and/or information obtained from other platforms. The processor may execute program instructions based on such data, information, and/or processing results to perform one or more of the functions described in the present disclosure.

In some embodiments, the government supervision management platform 130 may also be configured on a server used by the government. The server may process data and/or information obtained from other platforms. The server may execute program instructions based on such data, information, and/or processing results to perform one or more of the functions described in the present disclosure.

In some embodiments, the government supervision management platform 130 may exchange data with the government safety supervision service platform 121 and the government supervision sensor network platform 140.

In some embodiments, the government supervision management platform 130 includes a government safety supervision management platform 131. The government safety supervision management platform 131 refers to a platform for safety supervision and management of a gas pipeline network.

In some embodiments, the government safety supervision management platform 131 may coordinate and harmonize the connection and collaboration between the functional platforms, and converge all the information of the Internet of Things, and provide the perception management and control management functions for the Internet of Things operation system.

In some embodiments, the government safety supervision management platform 131 may exchange data with a government safety supervision sensor network platform 141.

The government supervision sensor network platform 140 refers to an interface platform that enables interaction between the government supervision management platform 130 and the gas company management platform 151. The government supervision sensor network platform 140 is configured as a communication device and/or server.

In some embodiments, the government supervision sensor network platform 140 may interact upwardly with the government supervision management platform 130 and downwardly with the gas company management platform 151.

The government safety supervision sensor network platform 141 refers to a functional platform for managing government sensor communications. In some embodiments, the government safety supervision sensor network platform 141 may be configured as a communication network or gateway, etc., and may perform the functions of perception and controlling information sensor and communication.

In some embodiments, the government safety supervision sensor network platform 141 may interact upwardly with the government safety supervision management platform 131 and downwardly with the gas company management platform 151. For example, the gas company management platform 151 may send gas data, gas supply data, environmental data, or the like, and related to hydrogen-blended gas production and transmission, via the government safety supervision sensor network platform 141 to the government safety supervision management platform 131.

The government supervision object platform 150 refers to a platform for generating government supervision information and controlling the execution of the information. In some embodiments, the government supervision object platform includes the gas company management platform 151 and major gas-consuming enterprises.

In some embodiments, the government supervision object platform 150 may interact upwardly with the government supervision sensor network platform 140 and downwardly with the gas company sensor network platform 160.

The gas company management platform 151 is a comprehensive management platform for gas company information.

In some embodiments, the gas company management platform 151 is configured to perform the method for hydrogen-blended gas transmission of smart gas. More descriptions regarding the method for hydrogen-blended gas transmission of smart gas may be found in the related descriptions below.

In some embodiments, the gas company management platform 151 may include a processor. The processor may process data and/or information obtained from other platforms. The processor may execute program instructions based on such data, information, and/or processing results to perform one or more of the functions described in the present disclosure.

The gas company sensor network platform 160 refers to a platform for managing gas company sensor information. In some embodiments, the gas company sensor network platform 160 may be configured as a communication network or gateway, etc.

In some embodiments, the gas company sensor network platform 160 may interact upwardly with the government supervision object platform 150, and downwardly with the smart gas device object platform 170.

The smart gas device object platform 170 refers to a functional platform for generating the perception information and controlling the execution of the information for the gas company. In some embodiments, the smart gas device object platform 170 includes a hydrogen input device and a gas monitoring device.

The hydrogen input device refers to a device or apparatus that input hydrogen gas to a gas pipeline.

In some embodiments, the hydrogen input device includes a hydrogen storage unit, a hydrogen buffer unit, a hydrogen pressure regulation unit, and a transmission pipeline.

The hydrogen storage unit refers to a structure for storing hydrogen. In some embodiments, the hydrogen storage unit may be a storage tank or other devices that may be used to store hydrogen.

The hydrogen buffer unit refers to a structure for adjusting pressure in the hydrogen storage unit. The hydrogen buffer unit may be disposed inside the hydrogen storage unit or connected to the hydrogen storage unit by a transmission pipeline.

In some embodiments, the hydrogen buffer unit may include a pressure regulator and a pressure sensor. The hydrogen buffer unit may automatically regulate the pressure in the hydrogen storage unit according to the feedback signal from the pressure sensor to keep pressure in the hydrogen storage unit within a safe range.

The hydrogen pressure regulation unit is configured to adjust the pressure and a flow rate of the hydrogen output to the gas pipeline network based on an injection parameter. In some embodiments, the hydrogen pressure regulation unit may be connected to the hydrogen storage unit by a transmission pipeline, or connected to the hydrogen buffer unit connected to the hydrogen storage unit by a transmission pipeline.

In some embodiments, the hydrogen pressure regulation unit may include a flow control valve, a pressure control valve, a pressure sensor, or the like. The hydrogen pressure regulation unit may adjust the amount of hydrogen output from the hydrogen storage unit by the flow control valve, and adjust the pressure of the output hydrogen by the pressure control valve.

The gas monitoring device refers to a device for obtaining various types of monitoring data in the gas pipeline network. In some embodiments, the gas monitoring device may include a gas composition analyzer, a pressure sensor device, a gas flow meter, or the like.

In some embodiments, the gas monitoring device is disposed in a gas pipeline of the gas pipeline network or in gas end-user equipment.

In some embodiments, the platform in the IoT system for hydrogen-blended gas transmission of smart gas may be divided into a smart gas primary network and a smart gas secondary network. The smart gas primary network refers to a network for government users to supervise the operation of the gas pipeline network. The smart gas secondary network refers to a network that includes the operation of the gas pipeline network. In some embodiments, a platform in the IoT system for hydrogen-blended gas transmission of smart gas may take on different roles in the smart gas primary network and the smart gas secondary network.

In some embodiments, the smart gas primary network includes at least a smart gas primary network user platform, a smart gas primary network service platform, a smart gas primary network management platform, a smart gas primary network sensor network platform, and a smart gas primary network object platform. The smart gas primary network user platform includes the user platform, the smart gas primary network service platform includes the government supervision service platform, the smart gas primary network management platform includes the government supervision management platform, and the smart gas primary network sensor network platform includes the government supervision sensor network platform, and the smart gas primary network object platform includes the government supervision object platform. The government supervision object platform may be the gas company management platform.

In some embodiments, the smart gas secondary network includes a smart gas secondary network user platform, a smart gas secondary network service platform, a smart gas secondary network management platform, a smart gas secondary network sensor network platform, and a smart gas secondary network object platform. The smart gas secondary network user platform includes a gas user platform, the smart gas secondary network service platform includes a gas user service platform, the smart gas secondary network management platform includes the gas company management platform, the smart gas secondary network sensor network platform includes the gas company sensor network platform, and the smart gas secondary network object platform includes the gas device object platform.

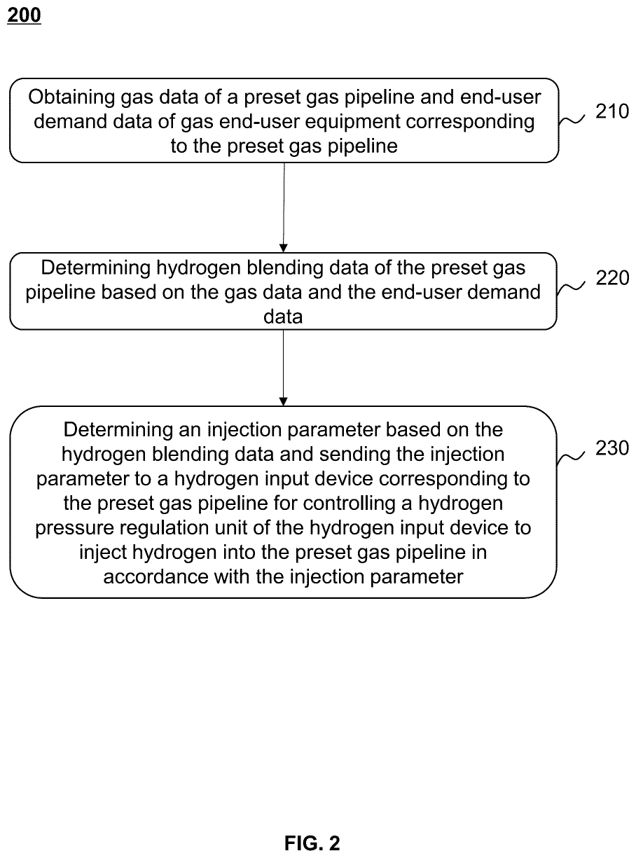

More descriptions regarding the IoT system for hydrogen-blended gas transmission of smart gas and its execution method may be found in FIGS. 2-4 and related descriptions thereof.

In some embodiments of the present disclosure, the IoT system for hydrogen-blended gas transmission of smart gas can establish information operation closed loops between functional platforms. This enables coordinated and regulated operation to achieve safety and stability during hydrogen-blended gas production and transmission, while ensuring enhanced combustion performance of the hydrogen-blended gas.

It should be noted that the above description of the IoT system for hydrogen-blended gas transmission of smart gas is only for the convenience of description, and does not limit the present disclosure to the scope of the cited embodiments. It is to be understood that for a person skilled in the art, after understanding the principle of the system, may be possible to arbitrarily combine various platforms or constitute sub-platforms to be connected to other platforms without departing from this principle.

In some embodiments, when implementing the method for hydrogen-blended gas transmission of smart gas, the government supervision management platform may obtain gas data of the preset gas pipeline and end-user demand data of gas end-user equipment corresponding to the preset gas pipeline; determine hydrogen blending data of the preset gas pipeline based on the gas data and the end-user demand data; and determine the injection parameter based on the hydrogen blending data and send the injection parameter to the hydrogen input device corresponding to the preset gas pipeline for controlling the hydrogen pressure regulation unit of the hydrogen input device to inject hydrogen into the preset gas pipeline in accordance with the injection parameter.

FIG. 2 is a flowchart illustrating an exemplary process for hydrogen-blended gas transmission of smart gas according to some embodiments of the present disclosure. As shown in FIG. 2, process 200 includes the following steps. In some embodiments, the process 200 may be performed based on a government supervision management platform of an IoT system for hydrogen-blended gas transmission of smart gas.

Step 210, obtaining gas data of a preset gas pipeline and end-user demand data of gas end-user equipment corresponding to the preset gas pipeline.

The preset gas pipeline refers to the most upstream gas pipeline in gas pipelines requiring hydrogen injection. The downstream of the preset gas pipeline includes one or more pieces of gas end-user equipment requiring hydrogen-blended gas. By blending hydrogen into the preset gas pipeline, the gas end-user equipment requiring hydrogen-blended in the downstream of the preset gas pipeline can obtain hydrogen-blended gas. The direction from upstream to downstream is the direction of gas transmission.

The gas data refers to data characterizing different substances in the gas and their contents.

In some embodiments, the government supervision management platform obtains the gas data of the preset gas pipeline from the gas company management platform via the government supervision sensor network platform. The gas data in the gas company management platform is obtained by the smart gas device object platform via a gas composition analyzer in the gas monitoring device and uploaded via the gas company sensor network platform.

The gas end-user equipment refers to gas consumption equipment corresponding to end-users who use gas. The gas end-user equipment includes at least one of gas consumption equipment corresponding to a residential user, gas consumption equipment corresponding to an industrial user, etc., and may also include gas consumption equipment corresponding to other types of users, which may be determined according to the actual situation.

The end-user demand data refers to a demand for using gas at the gas end-user equipment. The end-user demand data includes, but is not limited to, a calorific value demand.

The calorific value refers to an amount of heat released per unit of mass or volume of fuel when it is completely burned. The higher the calorific value, the better the quality of the fuel. In some embodiments, the gas end-user equipment corresponding to different types of users has different demands for the calorific value of the gas, e.g., the calorific value demand of industrial users is usually higher than that of residential users.

In some embodiments, the government supervision management platform may obtain the end-user demand data in multiple ways. For example, the government supervision management platform may obtain a plurality of pieces of gas supply data in the gas company management platform by the government supervision sensor network platform, determine a minimum calorific value corresponding to one of the plurality of pieces of gas supply data with an evaluation score exceeding an evaluation threshold, and determine the minimum calorific value as the end-user demand data. As another example, the government supervision management platform may obtain the end-user demand data uploaded by a user through the user platform by the government supervision service platform.

Step 220, determining hydrogen blending data of the preset gas pipeline based on the gas data and the end-user demand data.

The hydrogen blending data refers to data characterizing an amount of hydrogen injected into the preset gas pipeline. In some embodiments, the hydrogen blending data includes at least a hydrogen blending ratio, such as a volume percentage of hydrogen in the gas.

In some embodiments, the government supervision management platform may query in a preset calorific value table based on the gas data to obtain a calorific value of the gas in the preset gas pipeline before the injection of hydrogen.

The preset calorific value table includes a correspondence between reference gas data and reference calorific values. In some embodiments, the preset calorific value table may be obtained based on experimental or theoretical calculations.

It is known that there are two situations regarding the calorific value of the gas in the preset gas pipeline: one is that the calorific value of the gas before the injection of hydrogen is higher than the calorific value demand in the end-user demand data; and the other is that the calorific value of the gas before the injection of hydrogen is not higher than the calorific value demand in the end-user demand data. In some embodiments, in response to, in the preset gas pipeline, the calorific value of the gas before the injection of hydrogen being not higher than the calorific value demand in the end-user demand data, the government supervision management platform may set the hydrogen blending ratio to 0, i.e., no hydrogen is injected into the preset gas pipeline.

In some embodiments, in response to, in the preset gas pipeline, the calorific value of the gas before the injection of hydrogen being higher than the calorific value demand in the end-user demand data, the government supervision management platform may set the hydrogen blending ratio to a preset value. The preset value may be set based on a priori experience and/or actual demand.

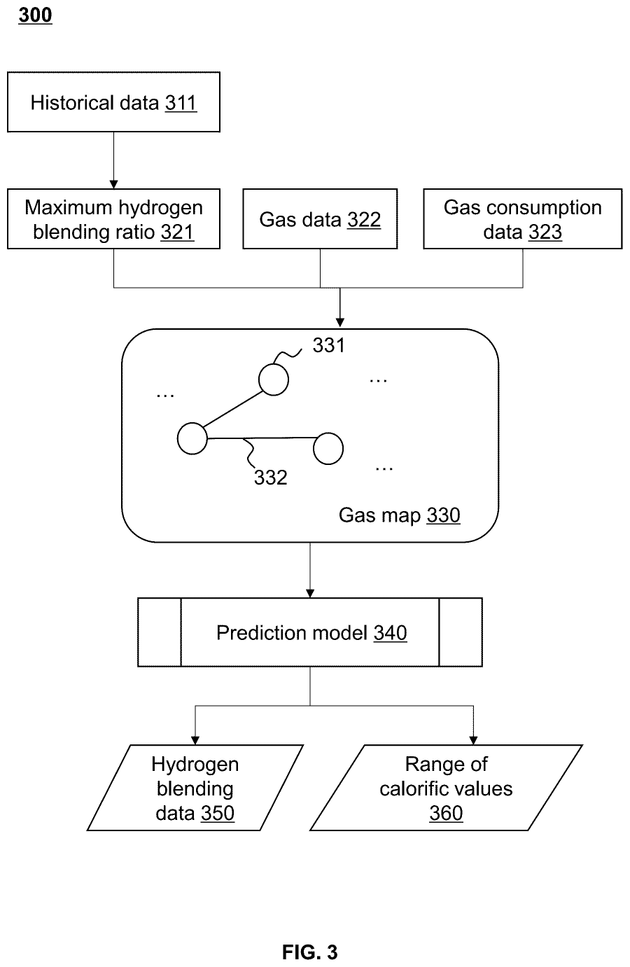

In some embodiments, the government supervision management platform may also determine a maximum hydrogen blending ratio based on the end-user demand data; and determine the hydrogen blending data based on the maximum hydrogen blending ratio, the gas data, and the end-user demand data. More detailed descriptions may be found in FIG. 3 and related descriptions thereof.

Step 230, determining an injection parameter based on the hydrogen blending data and sending the injection parameter to a hydrogen input device corresponding to the preset gas pipeline for controlling the hydrogen pressure regulation unit of the hydrogen input device to inject hydrogen into the preset gas pipeline in accordance with the injection parameter.

The injection parameter refers to an operating parameter of the hydrogen input device when hydrogen is injected. In some embodiments, the injection parameter may include parameters such as a hydrogen pressure and a hydrogen flow rate corresponding to the hydrogen input device. The injection parameter may also include other parameters, which may be determined depending on the actual demands.

In some embodiments, the government supervision management platform may query a reference input parameter table based on the hydrogen blending data to determine the injection parameter.

The reference input parameter table includes a correspondence between reference hydrogen blending data and reference injection parameters. The reference input parameter table may be obtained based on experimental or theoretical calculations.

In some embodiments, the government supervision management platform may also determine an original mean pressure and a pressure fluctuation of gas in the preset gas pipeline based on gas sequence data corresponding to the preset gas pipeline; and determine the injection parameter based on the original mean pressure, the pressure fluctuation, and the hydrogen blending data.

In some embodiments, the government supervision management platform may send the injection parameter to the hydrogen input device for controlling the hydrogen pressure regulation unit of the hydrogen input device to inject hydrogen into the preset gas pipeline in accordance with the injection parameter.

In some embodiments of the present disclosure, the hydrogen blending data is determined based on the end-user demand data, and the hydrogen pressure and flow rate during hydrogen injection into the preset gas pipeline are rationally derived based on the hydrogen blending data. This approach ensures safe hydrogen blending operations while satisfying calorific value demands of the end-users.

FIG. 3 is a schematic diagram illustrating a process for determining hydrogen blending data according to some embodiments of the present disclosure. As shown in FIG. 3, in some embodiments, the government supervision management platform may determine a maximum hydrogen blending ratio corresponding to the preset gas pipeline based on historical data; and determine the hydrogen blending data based on the maximum hydrogen blending ratio, the gas data, and the end-user demand data.

A maximum hydrogen blending ratio 321 refers to a maximum volume percentage of hydrogen by in a hydrogen-blended gas under the premise of ensuring normal gas usage.

In some embodiments, the government supervision management platform may determine the maximum hydrogen blending ratio 321 based on historical data 311. For example, the government supervision management platform may determine one or more historical hydrogen blending ratios in the historical data for normal gas usage by downstream users of the preset gas pipeline, and determine a maximum value from the historical hydrogen blending ratios as the maximum hydrogen blending ratio corresponding to the preset gas pipeline. In particular, normal gas usage means that the preset gas pipeline and its downstream pipelines do not require maintenance for a time period (e.g., one week, one month, etc.) and that there are no complaints or poor ratings from the gas users corresponding to the preset gas pipeline.

In some embodiments, the government supervision management platform may determine at least one set of first reference data based on historical data when the gas is in normal gas usage, one set of the first reference data including a historical maximum hydrogen blending ratio, historical gas data, historical end-user demand data and its corresponding historical hydrogen blending data; cluster the at least one set of first reference data to determine a plurality of clustering centers; construct a plurality of first reference vectors based on the historical maximum hydrogen blending ratio, the historical gas data, and the historical end-user demand data corresponding to each of the plurality of clustering centers; and determine the historical hydrogen blending data corresponding to each clustering center as a label for the first reference vector corresponding to the clustering center.

In some embodiments, the government supervision management platform may construct a first to-be-matched vector based on the maximum hydrogen blending ratio, the gas data, and the end-user demand data of the preset gas pipeline; match the first to-be-matched vector with the plurality of first reference vectors, respectively, and, based on a result of similarity calculation, determine a label corresponding to a first reference vector with a highest similarity to the first to-be-matched vector as the hydrogen blending data corresponding to the preset gas pipeline. The similarity may be determined based on a vector distance, which may include, but is not limited to, a Euclidean distance, a cosine distance, or the like.

In some embodiments, the government supervision management platform may construct a gas map 330 based on the maximum hydrogen blending ratio 321, gas data 322, and gas consumption data 323 of the gas end-user equipment during a preset time period; and determine hydrogen blending data 350 by a prediction model 340 based on the gas map 330.

The gas consumption data 323 refers to data indicating gas usage of the gas end-user equipment. For example, the gas consumption data may include a gas consumption amount, gas usage purpose, or other data related to the gas usage. For example, the gas usage purpose may include, but is not limited to, at least one of household gas usage, commercial gas usage, and industrial gas usage.

In some embodiments, the government supervision management platform may obtain the gas consumption amount from the gas company management platform by the government supervision sensor network platform, and determine the gas usage purpose based on a type of the gas end-user equipment. The smart gas device object platform may collect the gas consumption amount through a gas flow meter and upload the gas consumption amount to the gas company management platform through the gas company sensor network platform.

The gas map 330 refers to a map characterizing a gas situation and a pipeline connection relationship in a plurality of gas pipelines in the gas pipeline network. As an example, the gas map 330 may include nodes 331 and edges 332.

In some embodiments, the gas map includes a plurality of nodes, with one node corresponding to one gas pipeline.

In some embodiments, the nodes in the gas map have node features.

It is known that there are three situations regarding the gas pipelines in the gas pipeline network corresponding to the nodes: the gas pipeline corresponding to the node is a preset gas pipeline, the gas pipeline corresponding to the node is a gas end-user equipment pipeline, and the gas pipeline corresponding to the node is other than the preset gas pipeline or the gas end-user equipment pipeline. In some embodiments, when the gas pipeline corresponding to the node is a preset gas pipeline, the corresponding node feature includes a maximum hydrogen blending ratio and gas data of the preset gas pipeline; when the gas pipeline corresponding to the node is a gas end-user equipment pipeline, the corresponding node feature includes gas consumption data of the gas end-user equipment; when the gas pipeline corresponding to the node is other than the preset gas pipeline or the gas end-user equipment pipeline, the corresponding node feature includes gas data of the gas pipeline. The gas end-user equipment pipeline refers to a gas pipeline connected to the gas end-user equipment.

More descriptions regarding obtaining the maximum hydrogen blending ratio, the gas data, and the gas consumption data may be found in the related descriptions above.

In some embodiments, the node feature corresponding to the node characterizing the preset gas pipeline in the gas map may further include at least one of an original mean pressure and a pressure fluctuation.

The original mean pressure refers to an average value of the gas pressure in the gas pipeline during a time period before the injection of hydrogen. The pressure fluctuation reflects the fluctuation of the gas pressure in the gas pipeline during a time period before the injection of hydrogen.

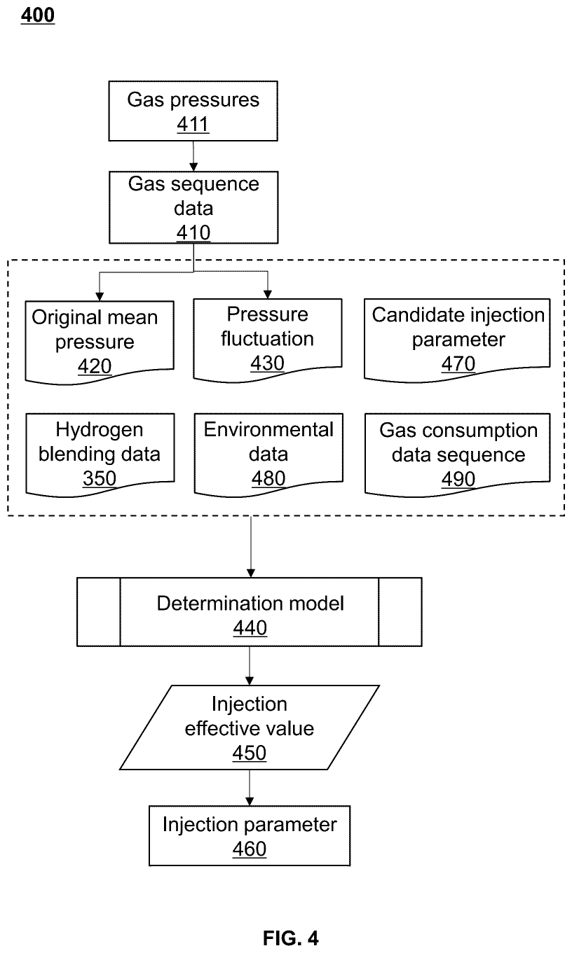

In some embodiments, the original mean pressure and the pressure fluctuation value may be determined based on gas sequence data. More descriptions may be found in FIG. 4 and related descriptions thereof.

In some embodiments of the present disclosure, the construction of the gas map incorporates both the original mean pressure and the pressure fluctuation in the gas pipeline before the injection of hydrogen. This methodology captures dynamic pressure features within gas pipelines, enabling more accurate determination of the hydrogen blending data based on the gas map.

In some embodiments, the node feature corresponding to the nodes characterizing the preset gas pipeline or other gas pipelines in the gas map may also include environmental data of the location where the gas pipeline corresponding to the nodes is located.

The environmental data refers to environmental feature data characterizing the location where the gas pipeline is located. For example, the environmental data may include at least one of temperature, humidity, atmospheric pressure, or the like at the location where the gas pipeline is located.

In some embodiments, the government supervision management platform may obtain the environmental data from the gas company management platform via the government supervision sensor network platform. The environmental data in the gas company management platform may be obtained from the smart gas device object platform via the gas company sensor network platform. For example, the smart gas device object platform obtains the temperature of the location where the gas pipeline is located through a temperature sensor, obtains the humidity of the location where the gas pipeline is located through a humidity sensor, obtains the atmospheric pressure of the gas pipeline location through a barometer, and uploads the environmental data to the gas company management platform via the gas company sensor network platform.

In some embodiments of the present disclosure, when constructing the gas map, by considering the environmental data of the location where the gas pipeline is located, the constructed gas map contains more information affecting the gas transmission, which is more in line with the actual situation, and is conducive to determining hydrogen blending data more accurately based on the gas map.

In some embodiments, the gas map further includes a plurality of edges connecting the nodes. The edge reflects a connection relationship between two nodes corresponding to gas pipelines. An edge exists between the nodes corresponding to these two gas pipelines if the two gas pipelines are connected. The edges of the gas map are directed edges, and the direction of the edges is consistent with the direction of gas flow.

In some embodiments, the edges in the gas map have edge features.

In some embodiments, an edge feature corresponding to an edge in the gas map includes a direction of gas flow.

In some embodiments, the government supervision management platform may determine the hydrogen blending data through the prediction model.

The prediction model may be a machine learning model. For example, the prediction model may be a Graph Neural Networks (GNN) model or other machine learning model obtained by training.

In some embodiments, an input to the prediction model includes a gas map, and an output to a prediction model includes hydrogen blending data output from a corresponding node of a preset gas pipeline.

In some embodiments, the output of the prediction model may also include a range of calorific values 360 output by the node corresponding to the gas end-user equipment pipeline. The range of calorific values may characterize a range of calorific values corresponding to hydrogen-blended gas in the gas end-user equipment pipeline after injecting hydrogen into the gas based on the hydrogen blending data.

The range of calorific values refers to a range of calorific value variation corresponding to combustion of the hydrogen-blended gas. For example, the range of calorific value variation may include a maximum calorific value and a minimum calorific value corresponding to the hydrogen-blended gas.

In some embodiments, the government supervision management platform may determine whether the hydrogen blending data is available based on the range of calorific values output from the corresponding node of the gas end-user equipment pipeline. For example, the government supervision management platform may obtain at least one gas consumption data corresponding to the gas end-user equipment at at least one preset time point; determine the at least one range of calorific values by a preset model; in response to a coverage degree of the at least one range of calorific values over the calorific value corresponding to the end-user demand data being higher than a threshold value, determine the hydrogen blending data being available; conversely, determine the hydrogen blending data being not available, and determine new hydrogen blending data in accordance with the aforesaid operations and carry out a next round of determination.

In some embodiments, the government supervision management platform may train an initial prediction model based on a plurality of sample datasets with sample labels, and obtain the prediction model by performing at least one round of iterations by a gradient descent manner or other feasible training manners. As an example, the at least one round of iterations may include that: the government supervision management platform input the plurality of sample datasets into the initial prediction model, constructs a loss function based on an output of the initial prediction model and the sample labels, and inversely updates parameters of the initial prediction model based on the value of the loss function; and the training ends when an iteration end condition is triggered, and the trained prediction model is obtained. The iteration end condition may include at least one of the loss function converging, and a count of iterations reaching a threshold.

In some embodiments, the sample dataset includes a sample gas map, and the sample gas map may be constructed based on historical data during normal gas usage, referring to the process for constructing the gas map described above.

In some embodiments, the sample labels may include historical hydrogen blending data corresponding to the node representing the preset gas pipeline in the sample gas map. The historical hydrogen blending data may be determined based on actual hydrogen blending data in the historical data during normal gas usage.

In some embodiments, the sample labels may also include a range of historical calorific values corresponding to the node of the gas end-user equipment pipeline in the sample gas map. The range of historical calorific values refer to a range of calorific value variation corresponding to the combustion of hydrogen-blended gas in the historical data.

In some embodiments, the range of historical calorific values variation may be determined based on a variety of manners.

When hydrogen-blended gas in the gas end-user equipment pipeline is available, the government supervision management platform may determine the range of historical calorific values based on the results of multiple sampling measurements. As an example, the government supervision management platform may carry out multiple sampling measurements of the hydrogen-blended gas in the gas end-user equipment pipeline during a preset historical time period, measure the calorific value corresponding to sampled gas obtained by the sampling measurements through actual combustion, and determine the range of historical calorific values based on the highest calorific value and the lowest calorific value obtained from the multiple sampling measurements.

When the hydrogen-blended gas in the gas end-user equipment pipeline is not available, the government supervision management platform may obtain historical gas consumption amount of the gas end-user equipment during a first historical time period and a second historical time period from the gas company management platform via the government supervision sensor network platform. The first historical time period is a time period before the injection of hydrogen, and the historical gas calorific value during the first historical time period may be obtained by collecting gas from a gas gate station for testing. The second historical time period is a time period after the injection of hydrogen. The length of the second historical time period is the same as the length of the first historical time period. As an example, the length of the first historical time period or the length of the second historical time period may be a week, ten days, etc., and may be determined based on actual situations.

Theoretically, the calorific demand of the gas end-user equipment remains constant, meaning that the calorific demand of the gas end-user equipment remains consistent over the same length of time. Therefore, the government supervision management platform may determine the historical gas calorific value after the injection of hydrogen based on the following equation:

$${K}_{1} * {q}_{1} = {K}_{2} * {q}_{2}$$

where K₁ is a gas consumption amount during the first historical time period; q₁ is a historical gas calorific value before the injection of hydrogen; K₂ is a gas consumption amount during the second historical time period; and q₂ is a historical gas calorific value to be solved after the injection of hydrogen.

In some embodiments, the government supervision management platform may obtain the historical gas calorific value after the injection of hydrogen during at least one historical time period in the manner described above, and determine a range of historical calorific values after the injection of hydrogen based on the maximum calorific value and minimum calorific value thereof.

In some embodiments, the government supervision management platform may split a sample dataset in accordance with a preset ratio to obtain a training set, a validation set, and a test set; and train an initial prediction model using the training set, the validation set, and the test set to obtain the prediction model.

The preset ratio refers to a pre-set ratio of the training set, the validation set and the test set. For example, the ratio of the count of samples included in the training set, the validation set, and the test set may be 8:1:1.

In some embodiments, the preset ratio may be preset by the government supervision management platform based on default settings or a priori experience.

In some embodiments, the government supervision management platform may split the sample dataset based on the preset ratio to obtain the training set, the validation set, and the test set.

The manner of splitting may include sampling statistics, which may include, but are not limited to, random sampling, stratified sampling, or the like. In some embodiments, the gas company management platform may also split the sample dataset in other manners.

In some embodiments, the training set refers to a dataset used to adjust learning parameters of the model during model training. The learning parameters may include parameters such as weights, biases, or the like. The validation set refers to a dataset used to adjust model hyperparameters during model training. The hyperparameters may include a count of network layers, a count of network nodes, a count of iterations, a learning rate, or the like. The test set refers to a dataset used to evaluate the performance of the final model.

There is no data crossover between the training set, the validation set, and the test set obtained by splitting, i.e., there is no duplicate data between any two of the training set, the validation set, and the test set.

In some embodiments, the government supervision management platform may train the initial prediction model based on the training set, the validation set, and the test set to obtain the prediction model. The process of training includes a plurality of stages for training. One stage for training may include several processes. For example, the training set may be input to the initial prediction model. A loss function may be constructed based on the sample labels and the output to the initial prediction model, and parameters of the initial prediction model are iterated based on the loss function. In the training process, a trained initial prediction model may be validated through the validation set based on a preset validation frequency, and an initial learning rate or the learning rate during training of the initial prediction model after the round of training may be adjusted based on validation results. Until a preset condition is triggered, the training ends and the obtained prediction model may be tested through the test set to evaluate the performance of the obtained prediction model. By performing the plurality of stages of training, the best performance prediction model is determined as the trained prediction model. The learning rate may be adjusted by a variety of strategies, such as, one or more of a learning rate decay strategy, learning rate warm-up, a cyclic learning rate, and an adjustment algorithm using an adaptive learning rate. The preset condition may include one or more of the count of iterations reaching a threshold, the loss function converging, and the value of the loss function being less than a preset threshold.

The process of model training using the training set, the validation set, and the test set is only exemplary, and other processes known to those of skill in the art may be used in model training based on the training set, the validation set, and the test set.

In some embodiments, the sample dataset may include a plurality of sets of sample data, one set of sample data may be divided into a training set, a validation set, and a test set in accordance with the preset ratio as previously described, and the government supervision management platform may carry out training of the initial prediction model based on the plurality of sets of divided sample data.

In some embodiments, a learning rate corresponding to one set of sample data is related to a sample confidence of the set of sample data, and the higher the sample confidence, the greater the learning rate corresponding to the set of sample data.

In some embodiments, the sample confidence of one set of sample data may be determined based on the availability of the sample label. The availability of the sample label refers to whether or not the label in the sample data may be obtained by sampling the actual measurements. As an example, the sample confidence may be a percentage of a count of nodes corresponding to the gas end-user equipment pipeline that are available relative to a total count of nodes corresponding to the gas end-user equipment pipeline. It is understandable that a sample label obtained through actual sampling measurements has higher accuracy. In one set of sample data, the larger the proportion of such labels, the higher the sample confidence.

In some embodiments of the present disclosure, training the prediction model based on the training set, the test set, and the validation set enhances robustness of the prediction model and prevents overfitting. For high-confidence samples, appropriately increasing the learning rate enables thorough model training, thereby improving the accuracy of the hydrogen blending data determination.

In some embodiments of the present disclosure, determining the hydrogen blending data by the prediction model leverages the learning capabilities of machine learning model to accurately establish the hydrogen blending data. This approach better ensures both the safety and effectiveness of hydrogen injection operations.

In some embodiments of the present disclosure, determining the hydrogen blending data based on the gas data and the end-user demand data enables establishment of more rational hydrogen blending data while satisfying the end-user demand data. This approach better ensures both safe gas transmission and reliable of normal gas usage.

FIG. 4 is a schematic diagram illustrating a process for determining an injection parameter according to some embodiments of the present disclosure.

As shown in FIG. 4, in some embodiments, the government supervision management platform may also determine an original mean pressure 420 and a pressure fluctuation 430 of gas in a preset gas pipeline based on gas sequence data 410 corresponding to the preset gas pipeline; and determine an injection parameter 460 based on the original mean pressure 420, the pressure fluctuation 430, and the hydrogen blending data 350.

The gas sequence data 410 is a sequence of a plurality of pieces of gas data during a preset time period.

The preset time period may be a system default or specified by the user, for example, the preset time period is the last 24 hours.

In some embodiments, the government supervision management platform may obtain a plurality of pieces of gas data of the preset gas pipeline at a plurality of time points during a preset time period based on historical data, and order the plurality of pieces of gas data according to the sequence of their acquisition time to form the gas sequence data.

In some embodiments, the government supervision management platform may determine the original mean pressure 420 and the pressure fluctuation 430 based on a plurality of gas pressures 411 in the gas sequence data 410. For example, the government supervision management platform may determine the original mean pressure based on an average of the plurality of gas pressures in the gas sequence data, and determine the pressure fluctuation based on a ratio of the original mean pressure to a standard deviation of the plurality of gas pressures in the gas sequence data.

In some embodiments, the government supervision management platform may determine at least one set of second reference data based on the historical data without failures, a set of second reference data including a historical mean pressure, a historical pressure fluctuation, historical hydrogen blending data, and a corresponding historical injection parameter; cluster the at least one set of second reference data to determine a plurality of clustering centers; construct a plurality of second reference vectors based on the historical mean pressure, the historical pressure fluctuation, and the historical hydrogen blending data corresponding to each of the plurality of clustering centers; and determine the historical injection parameter corresponding to each clustering center as a label for the second reference vector corresponding to the clustering center.

In some embodiments, the government supervision management platform may construct a second to-be-matched vector based on the original mean pressure, the pressure fluctuation, and the hydrogen blending data of the preset gas pipeline; and match the second to-be-matched vector with the plurality of second reference vectors, respectively; and determine, according to the results of similarity, the label corresponding to the second reference vector having the highest similarity to the second to-be-matched vector as the injection parameter of the preset gas pipeline. The similarity may be determined based on a vector distance, which may include, but is not limited to, a Euclidean distance, a cosine distance, or the like.

In some embodiments, the government supervision management platform may determine an injection effective value 450 corresponding to a candidate injection parameter by a determination model 440 based on a candidate injection parameter 470, the original mean pressure 420, the pressure fluctuation 430, and the hydrogen blending data 350; and determine the injection parameter 460 among a plurality of candidate injection parameters based on injection effective values of the plurality of candidate injection parameters.

The determination model 440 may be a machine learning model. For example, the determination model is a Neural Network (NN) model, a Deep-Learning Neural Network (DNN) model, or other machine learning model obtained by training.

In some embodiments, input to the determination model 440 include the candidate injection parameter 470, the original mean pressure 420, the pressure fluctuation 430, and the hydrogen blending data 350, and an output to the determination model 440 includes the injection effective value 450 corresponding to the candidate injection parameter.

The candidate injection parameter refers to an alternative injection parameter.

In some embodiments, the government supervision management platform may determine the top N most frequently used injection parameters in the historical data as the candidate injection parameters. The count N may be set based on a priori experience and/or actual needs.

The injection effective value refers to a value used to measure the effect of hydrogen injection based on a candidate injection parameter. The larger the injection effective value, the better the effect of hydrogen injection based on the candidate injection parameter. The hydrogen-blended gas obtained can better satisfy user requirements while maintaining safety.

In some embodiments, the government supervision management platform may obtain a trained determination model by training an initial determination model based on a plurality of training samples with training labels using a gradient descent manner or other manners. The training process is similar to that of the initial prediction model. More descriptions may be found in FIG. 3 and related descriptions thereof.

The training samples include sample injection parameters, sample mean pressures, sample pressure fluctuations, and sample hydrogen blending data. The training samples may be constructed based on historical data during normal gas usage. More descriptions regarding the normal gas usage may be found in FIG. 3 and related descriptions thereof.

The training labels are actual injection effective values corresponding to the training samples.

In some embodiments, the government supervision management platform may match actual measured data in the preset gas pipeline for a time period (e.g., one week) after the injection of hydrogen with standard data, and determine an actual injection effective value based on a matching result.

The actual measured data may include an actual gas pressure, an actual gas calorific value, and an actual gas flow rate. The standard data may include a standard pressure interval, a standard calorific value interval, and a standard flow rate interval.

As an example, the government supervision management platform may determine the matching values of the actual gas pressure and the standard pressure interval, the actual gas calorific value and the standard calorific value interval, and the actual gas flow rate and the standard flow rate interval. If the value of the measured data is in the interval corresponding to the standard data, the matching value is 1. If the value of the measured data is not in the interval corresponding to the standard data, the matching value is determined based on a minimum distance between the value of the measured data and an endpoint of the interval corresponding to the standard data, and the smaller the minimum distance is, the higher the matching value is.

The government supervision management platform may weight and sum the matching values based on preset weights, and determine the result of the weighted sum as the actual injection effective value. The preset weights may be determined based on a priori experience and/or actual demands.

In some embodiments, the input to the determination model further includes environmental data 480 of a location where the preset gas pipeline is located. More descriptions regarding the environmental data may be found in FIG. 3 and related descriptions thereof.

In some embodiments, when the input to the determination model include the environmental data, the training samples may also include sample environmental data. The government supervision management platform may obtain the sample environmental data based on historical data.

In some embodiments of the present disclosure, when determining the injection effective value, the influence of the environmental data on the injection of hydrogen is taken into account. This approach allows for better prediction of the injection effective value in compliance with the actual environmental conditions, resulting in a more accurate injection effective value.

In some embodiments, the input to the determination model further includes a gas consumption data sequence 490 of gas end-user equipment during the preset time period.

The gas consumption data sequence is a sequence consisting of gas consumption data during the preset time period. More descriptions regarding the gas consumption data may be found in FIG. 3 and related descriptions thereof.

In some embodiments, the government supervision management platform may obtain a plurality of pieces of gas consumption data of the gas end-user equipment in a preset time period based on the historical data, and order the plurality of gas consumption data in a temporal sequence to obtain the gas consumption data sequence.

In some embodiments, when the input to the determination model include the gas consumption data sequence, the training samples may also include a sample gas consumption data sequence. The government supervision management platform may obtain the sample gas consumption data sequence based on the historical data.

In some embodiments of the present disclosure, when determining the injection effective value, the influence of uncertainty factors at the gas end-user equipment is taken into account, which enables more effective and safer pressure regulation during hydrogen injection.

In some embodiments, the government supervision management platform may determine the candidate injection parameter with a highest injection effective value 450 as the final used injection parameter 460.

In some embodiments of the present disclosure, the determination model establishes injection effective values for candidate injection parameters, and based on the injection effective value, the final injection parameter is derived. This approach yields a more accurate injection parameter, enhancing both hydrogen injection safety and combustion performance of the obtained hydrogen-blended gas.

In some embodiments of the present disclosure, when determining the injection parameter, accounting for both gas pressure and pressure fluctuation of gas ensures comprehensive consideration of pressure variations within the gas pipeline. This approach better guarantees safe gas transmission and use of gas.

Some embodiments of the present disclosure provide a non-transitory

computer-readable storage medium storing computer instructions. When reading the computer instructions in the storage medium, a computer may implement the method for hydrogen-blended gas transmission of smart gas.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. An Internet of Things (IoT) system for hydrogen-blended gas transmission of smart gas, wherein the IoT system comprise a user platform, a government supervision service platform, a government supervision management platform, a government supervision sensor network platform, a government supervision object platform, a gas company sensor network platform, and a smart gas device object platform;
the user platform is configured to obtain end-user demand data for a preset gas pipeline and upload the end-user demand data to the government supervision management platform by the government supervision service platform;
the government supervision management platform includes a government safety supervision management platform; the government supervision service platform includes a government safety supervision service platform;
the government supervision sensor network platform includes a government safety supervision sensor network platform;
the government supervision object platform includes a gas company management platform;
the smart gas device object platform includes a hydrogen input device and a gas monitoring device, the hydrogen input device is provided in the preset gas pipeline; wherein
the hydrogen input device includes a hydrogen storage unit, a hydrogen buffer unit, a hydrogen pressure regulation unit, and a transmission pipeline; the hydrogen storage unit, the hydrogen buffer unit, and the hydrogen pressure regulation unit are connected by the transmission pipeline; the hydrogen storage unit stores hydrogen gas input to a gas pipeline network, the hydrogen buffer unit is configured to buffer the hydrogen gas input to the gas pipeline network, and the hydrogen pressure regulation unit is configured to regulate an output hydrogen pressure based on an injection parameter; and
the gas monitoring device is provided in a gas pipeline of the gas pipeline network for obtaining gas data of the gas pipeline;
the gas company management platform is configured to:
obtain gas data of the preset gas pipeline from the smart gas device object platform by the gas company sensor network platform;
determine hydrogen blending data of the preset gas pipeline based on the gas data and the end-user demand data; and
determine the injection parameter based on the hydrogen blending data and send the injection parameter to the hydrogen input device corresponding to the preset gas pipeline for controlling the hydrogen pressure regulation unit of the hydrogen input device to inject hydrogen into the preset gas pipeline in accordance with the injection parameter.

2. The IoT system of claim 1, wherein the gas company management platform is further configured to:
determine a maximum hydrogen blending ratio corresponding to the preset gas pipeline based on historical data; and
determine the hydrogen blending data based on the maximum hydrogen blending ratio, the gas data, and the end-user demand data.

3. The IoT system of claim 2, the gas company management platform is further configured to:
construct a gas map based on the maximum hydrogen blending ratio, the gas data, and gas consumption data of gas end-user equipment during a preset time period; and
determine the hydrogen blending data and a range of calorific value variation by a prediction model based on the gas map, the prediction model being a machine learning model.

4. The IoT system of claim 3, the gas company management platform is further configured to:
split a sample dataset in accordance with a preset ratio to obtain a training set, a validation set, and a test set; the sample dataset being determined based on the historical data; and
train an initial prediction model using the training set, the validation set, and the test set to obtain the prediction model; wherein
the sample dataset includes a plurality pieces of sample data, and a learning rate corresponding to one piece of sample data is related to a sample confidence of the piece of sample data.

5. The IoT system of claim 3, wherein a node feature corresponding to a node in the gas map includes at least one of an original mean pressure and a pressure fluctuation.

6. The IoT system of claim 3, wherein a node feature corresponding to a node in the gas map includes environmental data of a location where a gas pipeline corresponding to the node is located.

7. The IoT system of claim 1, wherein the gas data further includes a gas pressure; and the gas company management platform is further configured to:
determine an original mean pressure and a pressure fluctuation of gas in the preset gas pipeline based on gas sequence data corresponding to the preset gas pipeline; the gas sequence data being determined based on a gas pressure of the preset gas pipeline during a preset time period; and
determine the injection parameter based on the original mean pressure, the pressure fluctuation, and the hydrogen blending data.

8. The IoT system of claim 7, wherein the gas company management platform is further configured to:
determine an injection effective value corresponding to a candidate injection parameter by a determination model based on the candidate injection parameter, the original mean pressure, the pressure fluctuation, and the hydrogen blending data, the determination model being a machine learning model; and
determine the injection parameter among a plurality of candidate injection parameters based on injection effective values of the plurality of candidate injection parameters.

9. The IoT system of claim 8, wherein an input to the determination model includes environmental data of a location where the preset gas pipeline is located.

10. The IoT system of claim 8, wherein an input to the determination model includes a gas consumption data sequence of gas end-user equipment during the preset time period.

11. A method for hydrogen-blended gas transmission of smart gas, implemented based on a gas company management platform of an Internet of Things (IoT) system for hydrogen-blended gas transmission of smart gas, comprising:
obtaining gas data of a preset gas pipeline and end-user demand data of gas end-user equipment corresponding to the preset gas pipeline;
determining hydrogen blending data of the preset gas pipeline based on the gas data and the end-user demand data; and
determining an injection parameter based on the hydrogen blending data and send the injection parameter to the hydrogen input device corresponding to the preset gas pipeline for controlling the hydrogen pressure regulation unit of the hydrogen input device to inject hydrogen into the preset gas pipeline in accordance with the injection parameter.

12. The method of claim 11, wherein the determining hydrogen blending data of the preset gas pipeline based on the gas data and the end-user demand data includes:
determining a maximum hydrogen blending ratio corresponding to the preset gas pipeline based on historical data; and
determining the hydrogen blending data based on the maximum hydrogen blending ratio, the gas data, and the end-user demand data.

13. The method of claim 12, further comprising:
constructing a gas map based on the maximum hydrogen blending ratio, the gas data, and gas consumption data of the gas end-user equipment during a preset time period; and
determining the hydrogen blending data and a range of calorific value variation by a prediction model based on the gas map, the prediction model being a machine learning model.

14. The method of claim 13, further comprising:
splitting a sample dataset in accordance with a preset ratio to obtain a training set, a validation set, and a test set; the sample dataset being determined based on the historical data; and
training an initial prediction model using the training set, the validation set, and the test set to obtain the prediction model; wherein
the sample dataset includes a plurality pieces of sample data, and a learning rate corresponding to one piece of sample data is related to a sample confidence of the piece of sample data.

15. The method of claim 13, wherein a node feature corresponding to a node in the gas map includes at least one of an original mean pressure and a pressure fluctuation.

16. The method of claim 13, wherein a node feature corresponding to a node in the gas map includes environmental data of a location where a gas pipeline corresponding to the node is located.

17. The method of claim 1, wherein the gas data further includes a gas pressure; and the method further comprises:
determining an original mean pressure and a pressure fluctuation of gas in the preset gas pipeline based on gas sequence data corresponding to the preset gas pipeline; the gas sequence data being determined based on a gas pressure of the preset gas pipeline during a preset time period; and
determining the injection parameter based on the original mean pressure, the pressure fluctuation, and the hydrogen blending data.

18. The method of claim 17, wherein the determining the injection parameter based on the original mean pressure, the pressure fluctuation, and the hydrogen blending data includes:
determining an injection effective value corresponding to a candidate injection parameter by a determination model based on the candidate injection parameter, the original mean pressure, the pressure fluctuation, and the hydrogen blending data, the determination model being a machine learning model; and
determining the injection parameter among a plurality of candidate injection parameters based on injection effective values of the plurality of candidate injection parameters.

19. The method of claim 18, wherein an input to the determination model includes environmental data of a location where the preset gas pipeline is located.

20. A non-transitory computer-readable storage medium, comprising computer instructions that, when read by a computer, direct the computer to implement the method for hydrogen-blended gas transmission of smart gas of claim 11.
